(19) United States
(12) Patent Application Publication
(10) Pub. No.: US 2023/0085135 A1
(43) Pub. Date: Mar. 16, 2023

(54) METHOD FOR PRODUCING A BIPOLAR PLATE, FUEL CELL HALF-PLATE, BIPOLAR PLATE AND FUEL CELL

(71) Applicant: Audi AG, Ingolstadt (DE)

(72) Inventors: Oliver Keitsch, Heilbronn (DE); Philipp Mohr, Vancouver (CA); Raimund Theo Ströbel, Heilbronn (DE)

(21) Appl. No.: 17/794,919

(22) PCT Filed: Nov. 24, 2020
(86) PCT No.: PCT/EP2020/083157

§ 371 Date: Jul. 22, 2022

(30) Foreign Application Priority Data
Jan. 23, 2020 (DE) 10 2020 101 530.5

(51) Int. Cl. H01M 8/1004; H01M 8/0247; H01M 8/0271; H01M 8/0297

(52) U.S. Cl. CPC H01M 8/1004; H01M 8/0247; H01M 8/0271; H01M 8/0297

(57) ABSTRACT

A method for producing a bipolar plate for a fuel cell having a membrane electrode assembly comprises providing a first fuel cell half-plate, which has a circumferential plate edge which has a first media channel offset inwardly from the plate edge and also a first flow field, providing a second fuel cell half-plate, which has a plate edge corresponding to the plate edge of the first fuel cell half-plate, and which has a second media channel offset inwardly from its plate edge and also a second flow field, the second media channel being aligned with the first media channel when the two fuel cell half-plates are stacked one above the other in perfect alignment, and joining the first fuel cell half-plate to the second fuel cell half-plate along a media-channel joint line framing the media channels, wherein a joint-line-free sealing region of the fuel cell half-plates borders the plate edges, on which a seal is fixed or is to be fixed, and the first fuel cell half-plate is joined to the second fuel cell half-plate along an additional frame joint line adjoining the media channel joint line or overlapping same, at least some sections of said additional frame joint line being offset along the plate edges in relation to the sealing region.

### BACKGROUND

### Technical Field

Embodiments of the invention relate to a method for producing a bipolar plate for a fuel cell having a membrane electrode assembly, comprising the steps of providing a first fuel cell half-plate, which has a circumferential plate edge which has a first media channel offset inwardly from the plate edge and also a first flow field, providing a second fuel cell half-plate, which has a plate edge corresponding to the plate edge of the first fuel cell half-plate, and which has a second media channel offset inwardly from its plate edge and also a second flow field, the second media channel being aligned with the first media channel when the two fuel cell half-plates are stacked one above the other in perfect alignment, and joining the first fuel cell half-plate to the second fuel cell half-plate along a media-channel joint line framing the media channels. Embodiments of the invention further relate to a fuel cell half-plate, a bipolar plate and a fuel cell.

### Description of the Related Art

Bipolar plates are used in fuel cells and fuel cell stacks. With the aid of the bipolar plates, the fuel is carried and distributed at an adjacent anode of a first fuel cell, on the one hand, and the cathode gas is carried and distributed at a cathode of an adjacent second fuel cell, the bipolar plate further providing conduits to carry a coolant. A bipolar plate is usually produced from two fuel cell half-plates formed as half-shells, being glued together in the case of bipolar plates made of graphite. Metallic bipolar plates typically comprise two fuel cell half-plates which are welded together for at least a portion.

Welded bipolar plates will be found in the documents KR 101 410 480 B1, U.S. Pat. No. 10,199,662 B2, DE 103 010 52 B4 and DE 10 2007 048 184 B3.

The bipolar plates indicated in the document carry three different media (reaction gases and coolant) in the smallest of space through the fuel cell stack to its active regions, in which the electrochemical reaction of the fuel cells occurs. It is necessary to carry the three media technically separated tightly from each other, while the separation or sealing off of the coolant flowing between the two fuel cell half-plates is often accomplished by a circumferential weld seam, typically situated outside the outermost sealing groove sealed off from the adjacent membrane unit. In addition, a further welding or a further joining must be carried out within this outermost sealing groove in order to separate the other two media (reaction gases) from the coolant. The welding is done encircling the main channels.

### BRIEF SUMMARY

Some embodiments include a method for producing a bipolar plate such that the active region can be maximized while reducing the manufacturing complexity. Some embodiments include a corresponding bipolar plate, a fuel cell half-plate, and a fuel cell.

The plate edges of the fuel cell half-plates being connected to each other have a sealing region, which in particular borders the plate edges directly and is free of a joint line. On this sealing region, a seal is fixed or can be fixed. In addition, the first fuel cell half-plate is joined to the second fuel cell half-plate along an additional frame joint line adjoining the media channel joint line or overlapping same, at least some sections of said additional frame joint line being offset along the plate edges in relation to the sealing region.

This comes with the advantage that the outermost joint is moved to the inside of the external seal, so that a design space benefit and better utilization of the design space is achieved especially in the region of the media channels. In addition, a coolant bypass is avoided, since the external seal is protected against additional leakage. Thanks to avoiding the coolant bypass, a more uniform distribution of the coolant among the channels is possible. In addition, pressure losses of coolant are reduced.

It has proven to be advantageous when the frame joint line is led through flow field channels at the joint side of the first and the second flow fields. In this way, a joint line, especially a weld seam, is moved to the first and the last channel of the active surface, which can be designed with or without a flow diversion (serpentines). In order to provide a reliable sealing joint line, it has proven to be advantageous when the flow field channels at the edge side are formed broader than the other flow field channels. In this way, contours other than straight contours can be provided for the joining.

Furthermore, the possibility is created for the frame joint line to be led in a transition region of the fuel cell half-plates, forming the transition from an electrochemically active region of the membrane electrode assembly, in which the fuel cell reaction occurs, to a passive region in which the fuel cell reactions do not occur. In one special embodiment, this region can be understood to be a membrane sealing region in which a seal for the membrane electrode assembly is fixed or will be fixed, in order to seal off the membrane electrode assembly laterally. The width of the transition region is dictated by the dimensions of the membrane electrode assembly, so that it will be more or less broad according to the design of the membrane electrode assembly. Since in this region a (slight) gas bypass already flows past the active surface of the fuel cell, an additional bypass through the joint, especially a weld, will be less important.

It has proven to be advantageous when the frame joint line runs in a straight line, since in this way a very short weld seam and thus very short production times can be realized.

In order to avoid any bypass mass flows, however, it has also proven to be advantageous when the frame joint line is zig zag, toothed, rectangular, step-shaped or wavy, and a still moderate bypass with moderate pressure losses will be present for a zig zag joint.

It has also proven to be advantageous when the frame joint line forms non-intersecting loops, so that a special layout at the joint seam with longer length, yet also with the largest possible pressure loss and with the smallest bypass can be realized.

In some embodiments, the fuel cell half plates described herein are suitable for producing a bipolar plate according to the method mentioned above. It possesses a circumferential plate edge having a media channel offset inwardly from the plate edge, and having a flow field, wherein a joint-line-free sealing region directly borders the plate edges, on which a seal is fixed or can be fixed. The benefits and features mentioned in connection with the method described herein also apply equally to the fuel cell half-plate described herein.

A bipolar plate may be produced in particular by one of the above-mentioned methods, wherein it comprises a first fuel cell half-plate and a second fuel cell half-plate. The first fuel cell half-plate has a circumferential plate margin or plate edge which has a first media channel offset inwardly from the plate edge and also a first flow field. Moreover, it has a second fuel cell half-plate, which has a plate edge corresponding to the plate edge of the first fuel cell half-plate, and which has a second media channel offset inwardly from its plate edge and also a second flow field, the second media channel being aligned with the first media channel. A joint-line-free sealing region borders the plate edges, on which a seal is fixed or can be fixed. The first fuel cell half-plate is joined to the second fuel cell half-plate along a media-channel joint line framing the media channels, and the first fuel cell half-plate is joined to the second fuel cell half-plate along an additional frame joint line adjoining the media channel joint line or overlapping same, at least some sections of said additional frame joint line being offset along the plate edges in relation to the sealing region. In this bipolar plate, the frame joint line is always situated inside the sealing region bordering the plate edges, so that there is a maximization of the active surface of the bipolar plate.

The benefits and features of the method described herein are also realized in the bipolar plate described herein. The same holds for a fuel cell as described herein, having a membrane electrode assembly and a bipolar plate as described herein.

The features and combinations of features mentioned in the specification, as well as the features and combinations of features mentioned below in the description of the figures and/or shown only in the figures, can be used not only in the particular indicated combination, but also in other combinations or standing alone. Thus, embodiments which are not explicitly shown or explained in the figures, yet which emerge from and can be created by separate combinations of features from the embodiments which have been explained, should also be seen as being encompassed and disclosed by the present disclosure.

### BRIEF DESCRIPTION OF THE SEVERAL VIEWS OF THE DRAWINGS

Further benefits, features and details will emerge from the claims, the following description of embodiments, and the drawings.

FIG. 1 shows a detailed cross-sectional view of a cutout portion of a fuel cell stack having a bipolar plate formed from two fuel cell half-plates.

FIG. 2 shows a schematic front view of a bipolar plate.

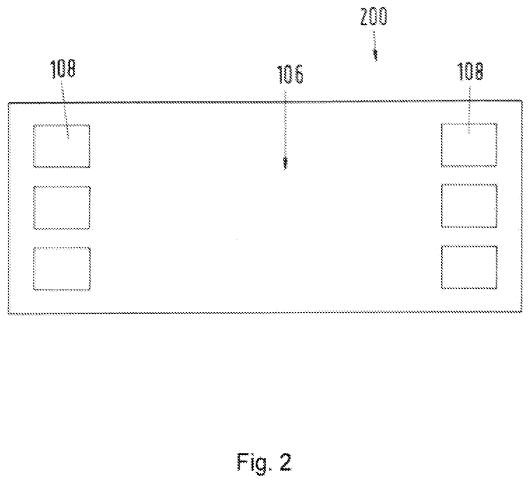

FIG. 3 shows a detailed front view of a first bipolar plate.

FIG. 4 shows a detailed front view of a second bipolar plate.

FIG. 5 shows a detailed front view of a third bipolar plate.

FIG. 6 shows a detailed front view of a fourth bipolar plate.

FIG. 7 shows a detailed front view of a fifth bipolar plate.

### DETAILED DESCRIPTION

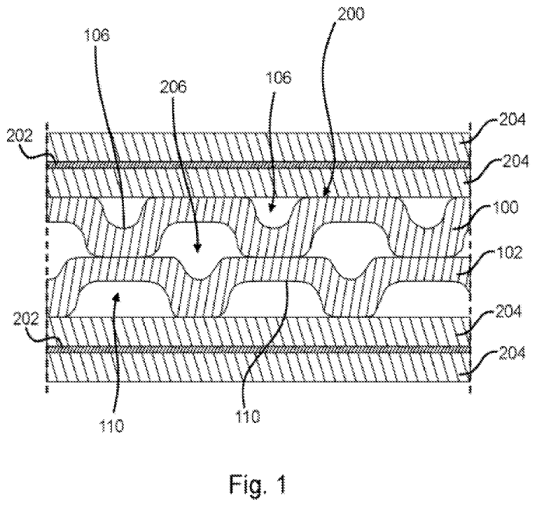

FIG. 1 shows a cutout portion of a fuel cell stack, being formed from multiple fuel cells. Each fuel cell is formed with a membrane electrode assembly 202, comprising a proton-conducting membrane, having an electrode associated with it on both sides. The membrane electrode assembly 202 is designed to carry out the electrochemical reaction of the fuel cell. In this process, a fuel (such as hydrogen) is taken to the electrode forming the anode, where it is catalytically oxidized to form protons, giving up electrons. These protons are transported through the proton-conducting membrane (or ion exchange membrane) to the cathode. The electrons derived from the fuel cell flow across an electrical consumer, such as an electric motor to propel a vehicle, or to a battery. The electrons are then taken to the cathode, or electrons are provided here. At the cathode, the oxidizing agent (such as oxygen or air containing oxygen) is reduced to anions by taking up electrons, which react immediately with the protons to form water.

With the aid of bipolar plates 200, the fuel or the cathode gas is conveyed to gas diffusion layers 204, which distribute the respective gases diffusely to the electrodes of the membrane electrode assembly 202. The fuel, the oxidizing agent, and optionally a coolant are taken through channels of the bipolar plate 200, bounded on both sides by webs of the bipolar plates 200 having web ridges. As can be seen from FIG. 1, each time a set of web ridges lies against a gas diffusion layer 204, so that a reactant flowing in the channels can be dispensed to the gas diffusion layer 204 and thus to the electrodes of the membrane electrode assembly 202.

The bipolar plate 202 in the present instance comprises two stacked fuel cell half-plates 100, 102, which can be joined together selectively, especially by welding, at their mutually facing webs 206, especially at their respective web ridges. The mutually facing webs of the fuel cell half-plates 100, 102 typically form conduits for a coolant, and hence a coolant flow field 206, with the channels lying between the webs.

It can furthermore be seen from FIG. 1 that the webs or the web ridges of the fuel cell half-plates 100, 102 need not necessarily have the same width, so that there may also be different widths and/or depths for the channels. However, for a durable connection of two fuel cell half-plates, it should be assured that at least two of the opposite facing webs lie against one another, and these can be durably connected to each other, in particular be joined, such as by welding.

The bipolar plate 200 thus encompasses multiple media channels 108, and each fuel cell half-plate 100, 102 is provided with a corresponding number of media channels 108. Each fuel cell half-plate 100, 102 comprises a plate edge 104, the media channels 108 being offset inwardly with respect to the plate edge 104 and every two of them are fluidically connected to one of the flow fields 106, 110 in order to bring the reaction media and/or the coolant into the flow fields. Since the two fuel cell half-plates 100, 102 are identical in configuration in the present case, their media channels 108 are aligned when they are stacked on each other in perfect alignment.

With the help of detail A we shall now describe how the bipolar plate 200 is put together from the two fuel cell half-plates 100, 102.

The bipolar plate 200 is joined, in particular welded, around the media channels 108 in order to seal off the coolant from the reactants. This is done by means of a media-channel joint line 114 framing the media channels 108. Laterally outside of this media-channel joint line 114 the external seal is then arranged in a joint-line-free sealing region 112 of the fuel cell half-plates 100, 102, bordering in particular the plate edges 104. In this joint-line-free sealing region 112 there may be fixed, or may already be fixed, a seal. In addition, the first fuel cell half-plate 100 is joined to the second fuel cell half-plate 102 along an additional frame joint line 116 adjoining the media-channel joint line 114 or overlapping this line, at least sections of which run along the plate edges 104, but always being offset relative to the sealing region 112. Hence, the joint-line-free sealing region is provided in order to put in place a circumferential seal encircling a certain joint line. In this way, a coolant bypass through the external seal is completely prevented, thus improving the equal distribution of the coolant in the coolant channels. Pressure losses of the coolant are reduced.

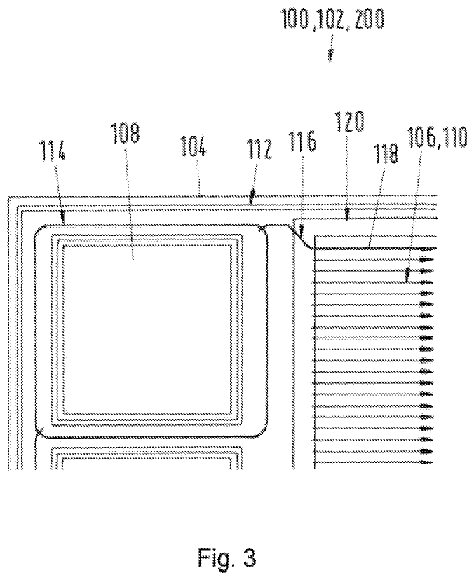

FIG. 3 concerns the possibility of moving the frame joint line 116 into in full-side flow channels 118 of the first and second flow fields 106, 110, where the edge-side flow field channels 118 may also be broader in configuration than the rest of the flow field channels 120, in order to achieve a desired joint contour between the two fuel cell half-plates 100, 102. In the configuration of FIG. 3, the frame joint line 116 runs straight along the likewise straight running flow field channels 118. But the possibility also exists here of having a serpentine flow field and making the frame joint line 116 follow the outermost channel.

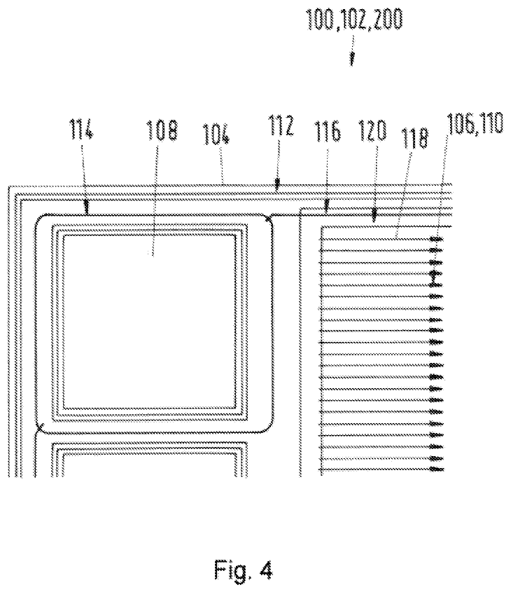

FIG. 4 concerns the possibility of moving the frame joint line 116 into a transition region 120 of the fuel cell half-plates 100, 102, in which a seal for the membrane electrode assembly is fixed or will be fixed later on. In this region, an already slight bypass for reactants exists anyway, so that an additional bypass through the layout of the joint line is not so important. Here as well, the possibility exists of having a straight joint or weld seam, which is optimized in regard to the time for its fabrication.

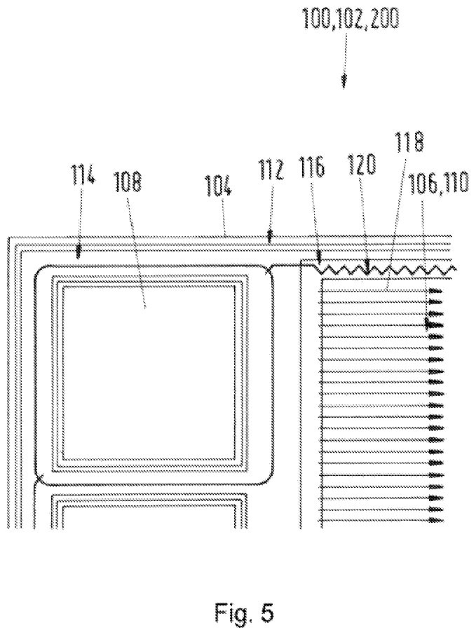

Since large bypass losses may still occur with a straight running frame joint line 116, FIG. 5 shows the possibility of a wavy or toothed frame joint line 116, which has a longer fabrication time, but provides a reduced bypass for reactants.

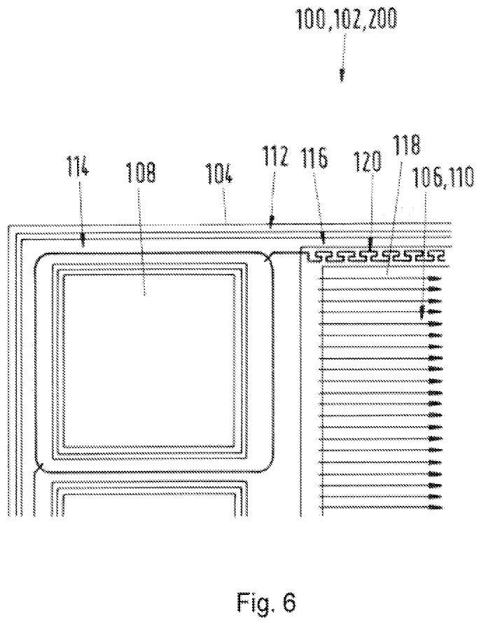

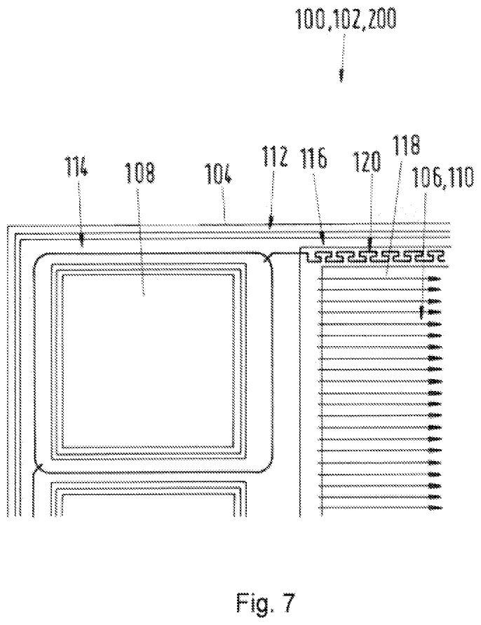

In order to further decrease this bypass, FIG. 6 shows the possibility of configuring the frame joint line 116 by means of non-intersecting loops. FIG. 7 shows a rectangular layout of the frame joint line 116.

The frame joint line 116 of all configurations may provide, together with the media-channel joint lines 114, a frame like joint layout. This is suitable in that the reactants and the coolant are further sealed off from each other, but also from the surroundings, by the layout of the joint. Thanks to a joint seam layout which is moved inward with respect to the edge seal, the active surface is maximized and the manufacturing complexity is reduced.

In general, in the following claims, the terms used should not be construed to limit the claims to the specific embodiments disclosed in the specification and the claims, but should be construed to include all possible embodiments along with the full scope of equivalents to which such claims are entitled.

1. A method for producing a bipolar plate for a fuel cell having a membrane electrode assembly, comprising:
providing a first fuel cell half-plate, which has a first circumferential plate edge which has a first media channel offset inwardly from the first circumferential plate edge and also a first flow field,
providing a second fuel cell half-plate, which has a second circumferential plate edge corresponding to the first circumferential plate edge of the first fuel cell half-plate, and which has a second media channel offset inwardly from the second circumferential plate edge and also a second flow field, the second media channel being aligned with the first media channel when the first and second fuel cell half-plates are stacked one above the other in alignment, and
joining the first fuel cell half-plate to the second fuel cell half-plate along a media-channel joint line framing the media channels,
wherein a joint-line-free sealing region of the first and second fuel cell half-plates borders the plate edges, on which a seal is fixed or is to be fixed,
wherein the first fuel cell half-plate is joined to the second fuel cell half-plate along an additional frame joint line adjoining the media channel joint line or overlapping the media channel joint line, at least some sections of said additional frame joint line being offset along the first and second plate edges in relation to the first and second sealing regions.

2. The method according to claim 1, wherein the frame joint line is led through flow field channels at the joint side of the first and the second flow fields.

3. The method according to claim 2, wherein the flow field channels at the edge side are formed broader than the other flow field channels.

4. The method according to claim 1, wherein the frame joint line is led in a transition region of the fuel cell half-plates, forming the transition from an electrochemically active region of the membrane electrode assembly to a passive region.

5. The method according to claim 1, wherein the frame joint line runs in a straight line.

6. The method according to claim 1, wherein the frame joint line is zig zag, toothed, rectangular, step-shaped or wavy.

7. The method according to one of claim 1, wherein the frame joint line forms non-intersecting loops.

8. A fuel cell half-plate having a circumferential plate edge, having a media channel offset inwardly from the plate edge, and having a flow field, wherein a joint-line-free sealing region directly borders the plate edges, on which a seal is fixed or can be fixed.

9. A bipolar plate comprising:
a first fuel cell half-plate, which has a first circumferential plate edge which has a first media channel offset inwardly from the first circumferential plate edge and also a first flow field,
a second fuel cell half-plate, which has a second circumferential plate edge corresponding to the first circumferential plate edge of the first fuel cell half-plate, and which has a second media channel offset inwardly from the second circumferential plate edge and also a second flow field, the second media channel being aligned with the first media channel,
wherein a joint-line-free sealing region of the fuel cell half-plates borders the first and second plate edges, on which a seal is fixed or is to be fixed,
wherein the first fuel cell half-plate is joined to the second fuel cell half-plate along an additional frame joint line adjoining the media channel joint line or overlapping the media channel joint line, at least some sections of said additional frame joint line being offset along the plate edges in relation to the sealing region.

10. A fuel cell having a membrane electrode assembly and a bipolar plate comprising:
a first fuel cell half-plate, which has a first circumferential plate edge which has a first media channel offset inwardly from the first circumferential plate edge and also a first flow field,
a second fuel cell half-plate, which has a second circumferential plate edge corresponding to the first circumferential plate edge of the first fuel cell half-plate, and which has a second media channel offset inwardly from the second circumferential plate edge and also a second flow field, the second media channel being aligned with the first media channel,
wherein a joint-line-free sealing region of the fuel cell half-plates borders the first and second plate edges, on which a seal is fixed or is to be fixed,
wherein the first fuel cell half-plate is joined to the second fuel cell half-plate along an additional frame joint line adjoining the media channel joint line or overlapping the media channel joint line, at least some sections of said additional frame joint line being offset along the plate edges in relation to the sealing region.
